(19) United States
(12) Patent Application Publication
(10) Pub. No.: US 2016/0232555 A1
(43) Pub. Date: Aug. 11, 2016

(54) REWARDS INFORMATION DETERMINING DEVICE AND REWARDS INFORMATION DETERMINING SYSTEM

(71) Applicant: NEC CORPORATION, Tokyo (JP)

(72) Inventors: Tsuyoshi SATOU, Tokyo (JP); Tatsushi HAMADA, Tokyo (JP)

(21) Appl. No.: 15/023,150

(22) PCT Filed: Oct. 10, 2014
(86) PCT No.: PCT/JP2014/005174

§ 371 Date: Mar. 18, 2016

(30) Foreign Application Priority Data
Oct. 30, 2013 (JP) 2013-224979

(51) Int. Cl. G06Q 30/02; G06Q 50/06; H02J 13/00

(52) U.S. Cl. CPC G06Q 30/0226; H02J 13/00; G06Q 50/06

(57) ABSTRACT

Provided is a rewards information determining device that can determine rewards information that indicates rewards to be provided to a power consumer according to the degree of power saving of the power consumer not to cause unfairness to the power consumer. Information acquiring means 81 acquires information of first consumed power consumed by the power consumer. Rewards information determining means 82 determines the rewards information of the power consumer based on information of standard consumed power of a group to which the power consumer belongs, and the information of first consumed power.

### TECHNICAL FIELD

The present invention relates to a rewards information determining device, a rewards information determining system, a rewards information determining method, and a rewards information determining program, which determine rewards information that indicates rewards to be provided to a power consumer according to the degree of power saving of the power consumer.

### BACKGROUND ART

Various systems for improving awareness of energy saving of power consumers who consume power have been proposed (for example, see PTLs 1 and 2).

PTL 1 describes classification of homes into groups according to the number of families, residential formation, a total floor area, an annual income, and the like. Further, PTL 1 describes a system of creating an energy-saving enlightenment message on a home to home basis from electricity expense frequency distribution of each group, an electricity expense average value of each group, rankings of electricity expenses of this month and rankings of electricity expenses of last month of the homes belonging to the group, and transmitting the enlightenment message to the homes. In PTL 1, an example of the energy-saving enlightenment message includes: “The electricity expenses seem larger than an average. Work on further energy saving”.

PTL 2 describes a system of generating a ranking of power consumers in ascending order of a year-on-year rate of power usage of the power consumers, acquiring household information of the power consumers including a site area and the number of people per household, and calculating points of the power consumers based on the household information and the ranking. Further, PTL 2 describes exchange of the points with goods.

### CITATION LIST

### Patent Literature

PTL 1: Japanese Patent Application Laid-Open No. 2003-162787 (paragraphs 0009 and 0011)

PTL 2: Japanese Patent Application Laid-Open No. 2010-218437 (paragraphs 0023, and 0027 to 0032)

### SUMMARY OF INVENTION

### Technical Problem

In the technology described in PTL 1, the awareness of energy saving of the power consumers is enhanced with the energy-saving enlightenment message. However, it is favorable to more effectively provide an incentive of the power saving to the power consumers.

In the technology described in PTL 2, the points are calculated based on the household information and the ranking. Therefore, the incentive of the power saving can be provided to the power consumers with the points. However, even if the household information including the site area and the number of people per household is used for the point calculation, unfairness is caused among the power consumers with regard to the calculated points. For example, between the power consumers who live in places in different climates, tendencies of power consumption are different. In the point calculating method described in PTL 2, such a difference in the tendencies is not taken into account. Therefore, unfairness is caused among the power consumers.

Therefore, an objective of the present invention is to provide a rewards information determining device, a rewards information determining system, a rewards information determining method, and a rewards information determining program that can determine rewards information that indicates rewards to be provided to a power consumer according to the degree of power saving of the power consumer not to cause unfairness to the power consumer.

### Solution to Problem

A rewards information determining device according to the present invention includes: information acquiring means configured to acquire information of first consumed power consumed by a power consumer; and rewards information determining means configured to determine rewards information of the power consumer based on information of standard consumed power of a group to which the power consumer belongs, and the information of first consumed power.

Further, a rewards information determining system according to the present invention includes: power measuring means configured to measure information of first consumed power consumed by a power consumer; and rewards information determining means configured to determine rewards information of the power consumer based on information of standard consumed power of a group to which the power consumer belongs, and the information of first consumed power.

Further, a rewards information determining method according to the present invention includes: acquiring information of first consumed power consumed by a power consumer; and determining rewards information of the power consumer based on information of standard consumed power of a group to which the power consumer belongs, and the information of first consumed power.

Further, a rewards information determining program according to the present invention causes a computer to execute: information acquiring processing of acquiring information of first consumed power consumed by a power consumer; and rewards information determining processing of determining rewards information of the power consumer based on information of standard consumed power of a group to which the power consumer belongs, and the information of first consumed power.

### Advantageous Effects of Invention

According to the present invention, the rewards information that indicates rewards to be provided to the power consumer can be determined according to the degree of power saving of the power consumer not to cause unfairness to the power consumer.

### BRIEF DESCRIPTION OF DRAWINGS

FIG. 1 It depicts a block diagram illustrating an example of a rewards information calculating system of a first exemplary embodiment of the present invention.

FIG. 2 It depicts an explanatory diagram schematically illustrating an example of information stored in a power storage unit.

FIG. 3 It depicts an explanatory diagram schematically illustrating an example of information stored in a standard consumed power storage unit.

FIG. 4 It depicts a sequence diagram illustrating an example of processing progress of the first exemplary embodiment.

FIG. 5 It depicts a block diagram illustrating an example of a rewards information calculating system of a second exemplary embodiment of the present invention.

FIG. 6 It depicts an explanatory diagram schematically illustrating an example of information stored in a power storage unit in the second exemplary embodiment.

FIG. 7 It depicts a sequence diagram illustrating an example of processing progress of the second exemplary embodiment.

FIG. 8 It depicts a block diagram illustrating a configuration example of a case where a HEMS 10 stores a power consumer ID, a group ID, attribute information of a home of a power consumer, and information of power.

FIG. 9 It depicts a block diagram illustrating principal portions of a rewards information determining device of the present invention.

FIG. 10 It depicts a block diagram illustrating principal portions of a rewards information determining system of the present invention.

### DESCRIPTION OF EMBODIMENTS

Hereinafter, exemplary embodiments of the present invention will be described with reference to the drawings.

### Exemplary Embodiment 1

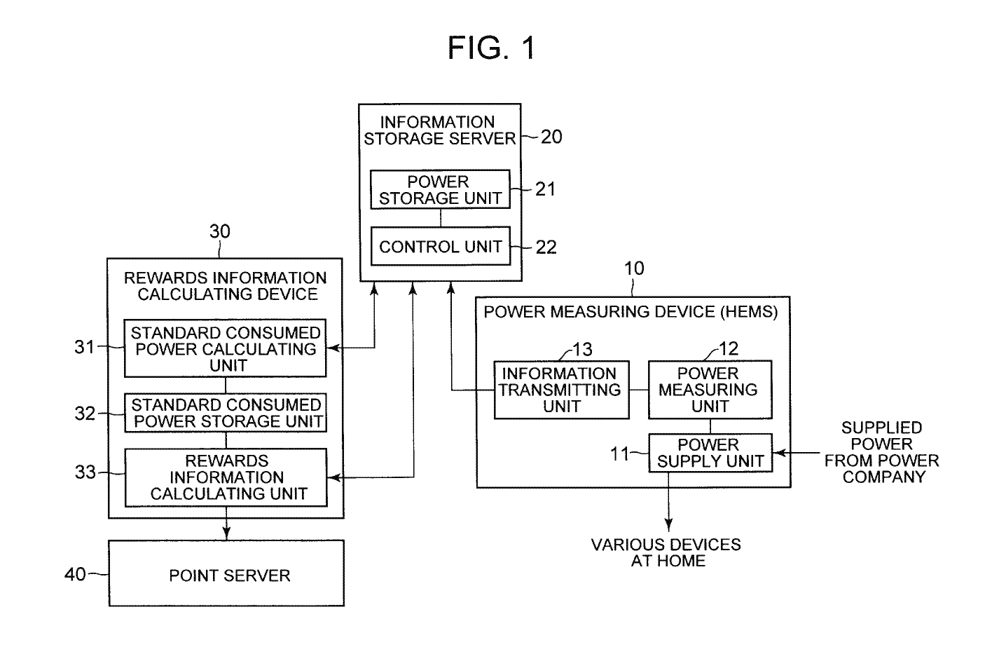

FIG. 1 is a block diagram illustrating an example of a rewards information calculating system of a first exemplary embodiment of the present invention. The rewards information calculating system of the present invention includes a power measuring device 10, an information storage server 20, and a rewards information calculating device 30. The rewards information calculating system can also be referred to as rewards information determining system. The rewards information calculating device can also be referred to as rewards information determining device.

Here, the rewards information is information that indicates rewards to be provided to a power consumer according to the degree of power saving of the power consumer. An example of the rewards information includes a point. The point is also called “loyalty point”, “rewards point”, or the like. However, in the description below, the rewards information is simply written as point. Further, the rewards information may be a value other than the point, such as money. However, in the description below, a case where the rewards information is the point will be exemplarily described. That is, a case where the rewards information calculating device 30 calculates the point as the rewards information will be exemplarily described.

The power measuring device 10 measures consumed power at home of the power consumer. In the following description of each exemplary embodiment, a case where the power measuring device 10 is realized by a home energy management system (HEMS) will be exemplarily described. Hereinafter, the power measuring device 10 is written as HEMS 10. FIG. 1 illustrates one HEMS 10. However, the HEMS 10 is provided in each home of the power consumer to which the point is provided by the present invention. In the description below, description will be given focusing on the HEMS 10 of one power consumer. However, other HEMSs, illustration of which is omitted, are also operated in a similar way to the way HEMS 10 is operated.

The information storage server 20 stores the consumed power of the home of the power consumer, which has been measured by the HEMS 10.

The rewards information calculating device 30 calculates the point for the power consumer. A rewards information calculating unit 33 is connected to a point server 40 that manages the point of a point service (loyalty program) used by the power consumer. The rewards information calculating device 30 transmits the calculated point to the point server 40. Although FIG. 1 illustrates one point server, the point server 40 is not limited to one. The power consumer specifies one point service in advance from among various point services (for example, a point service of a convenience store, a point service of an airline company, or the like) used by himself/herself. Then, the rewards information calculating device 30 transmits the point of the power consumer to the point server 40 corresponding to the point service specified by the power consumer in advance. The point server 40 adds the point as a point of the power consumer. In the present invention, the rewards information calculating device 30 calculates the point of the power consumer as a larger value as the power consumer performs more power saving. Therefore, the power consumer can receive more services with the point service used by himself/herself as the power consumer performs more power saving.

The HEMS 10 includes a power supply unit 11, a power measuring unit 12, and an information transmitting unit 13.

The power supply unit 11 receives supplied power from a power company, and supplies the power to devices at home of the power consumer.

The power measuring unit 12 measures consumed power of the home of the power consumer during a predetermined period, for each predetermined period (that is, the power supplied to the devices at home by the power supply unit 11). Hereinafter, a case in which the predetermined period is one month will be exemplarily described.

The information transmitting unit 13 transmits information of the consumed power of one month at home of the power consumer to the information storage server 20.

The power measuring unit 12 and the information transmitting unit 13 are, for example, realized by a central processing unit (CPU) of a computer operated according to a power measuring device program. In this case, the CPU may just read the program and be operated as the power measuring unit 12 and the information transmitting unit 13 according to the program.

Further, the HEMS 10 displays a power consumption state of the power consumer in a display device (not illustrated) of the power consumer, and performs optimization control of operations of the respective devices at home. However, the operations are not directly relevant to the present invention, and thus description is omitted.

The information storage server 20 includes a power storage unit 21 and a control unit 22.

The control unit 22 stores the information received from the HEMS 10 to the power storage unit 21, and transmits the information stored in the power storage unit 21 to the rewards information calculating device 30 in response to a request from the rewards information calculating device 30.

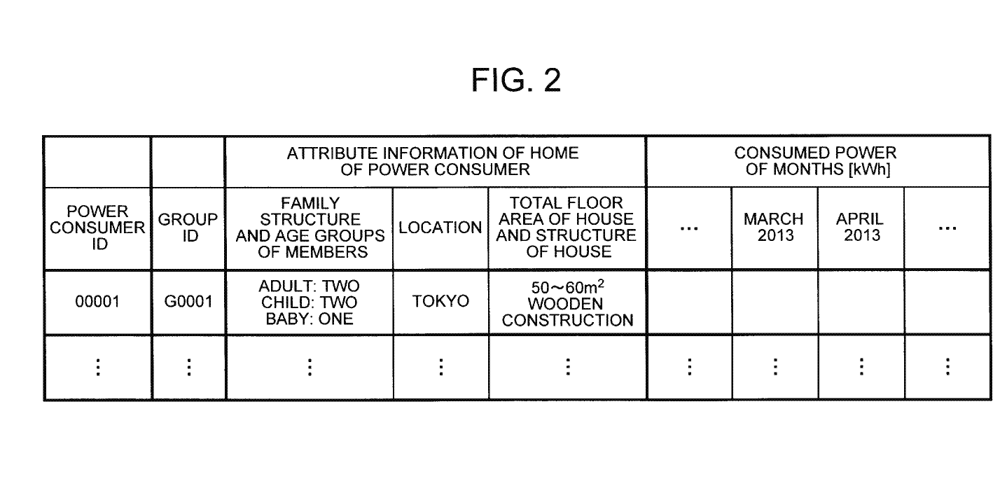

The power storage unit 21 is a storage device that stores, for each power consumer, a power consumer ID, a group ID, attribute information of the home of the power consumer, information of consumed power of each month. FIG. 2 is an explanatory diagram schematically illustrating an example of information stored in the power storage unit 21. The power consumer ID is identification (ID) allocated to each power consumer. Further, the example of FIG. 2 illustrates a case of storing a family structure and age groups of members who belong to the family of the power consumer, a location of a house, and a total floor area and the structure of the house, as the attribute information of the home of the power consumer. The attribute information of the home is transmitted from the individual power consumer to an administrator of the rewards information calculating system in advance, and the administrator stores the information to the power storage unit 21. Further, information of the consumed power of one month, which is notified from the information transmitting unit 13 of the HEMS 10 in each month, is stored in the power storage unit 21 as the consumed power of each month. Note that the power storage unit 21 may just store the information of the consumed power of a past given period, going back from the present.

Further, the homes of the power consumers are divided into groups based on the attribute information of the home such that the homes of the power consumers having the same attribute information belong to the same group. The group ID is an ID of the group to which the home of the power consumer belongs. Grouping of the power consumers and registration of the group ID to the power storage unit 21 may be performed by the administrator of the rewards information calculating system. Alternatively, the control unit 22 of the information storage server 20 may automatically perform the grouping and the registration.

The rewards information calculating device 30 includes a standard consumed power calculating unit 31, a standard consumed power storage unit 32, and a rewards information calculating unit 33.

The standard consumed power calculating unit 31 calculates, for each group, an average value of the consumed power of the homes of the power consumers who belong to the group, based on record of the past consumed power. The average value of the consumed power calculated for each group is written as standard consumed power. In the present exemplary embodiment, a case in which the standard consumed power calculating unit 31 calculates, for each group, the average value of the consumed power of the same month of last year of the homes of the power consumers who belong to the group, as the standard consumed power will be described.

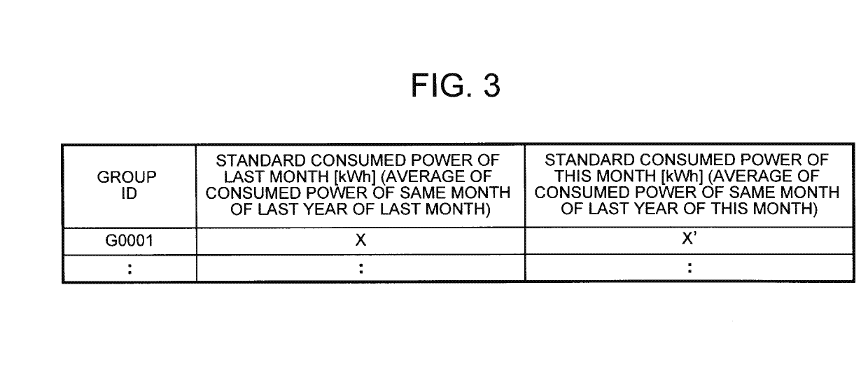

The standard consumed power storage unit 32 is a storage device that stores the standard consumed power calculated for each group. FIG. 3 is an explanatory diagram schematically illustrating an example of the information stored in the standard consumed power storage unit 32. As illustrated in FIG. 3, the standard consumed power storage unit 32 stores, for each group, the group ID and the standard consumed power in association with each other. In this example, a case in which the standard consumed power storage unit 32 stores a plurality of months of the standard consumed power calculated for each month (in the example illustrated in FIG. 3, two months including this month and last month) is described.

The rewards information calculating unit 33 acquires the power consumer IDs of the power consumers, the group ID, the information of the consumed power of one month from the information storage server 20, for each predetermined period (in this example, one month). The rewards information calculating unit 33 then calculates, for each power consumer, a point of one month of the power consumer, based on a value obtained by subtracting the consumed power from the standard consumed power of the group to which the power consumer belongs, and transmits the calculated point to the point server 40.

The standard consumed power calculating unit 31 and the rewards information calculating unit 33 are realized by the CPU of a computer operated according to a rewards information calculating program, for example. In this case, the CPU may just read the rewards information calculating program and be operated as the standard consumed power calculating unit 31 and the rewards information calculating unit 33 according to the program. The rewards information calculating program may be stored in a computer-readable recording medium.

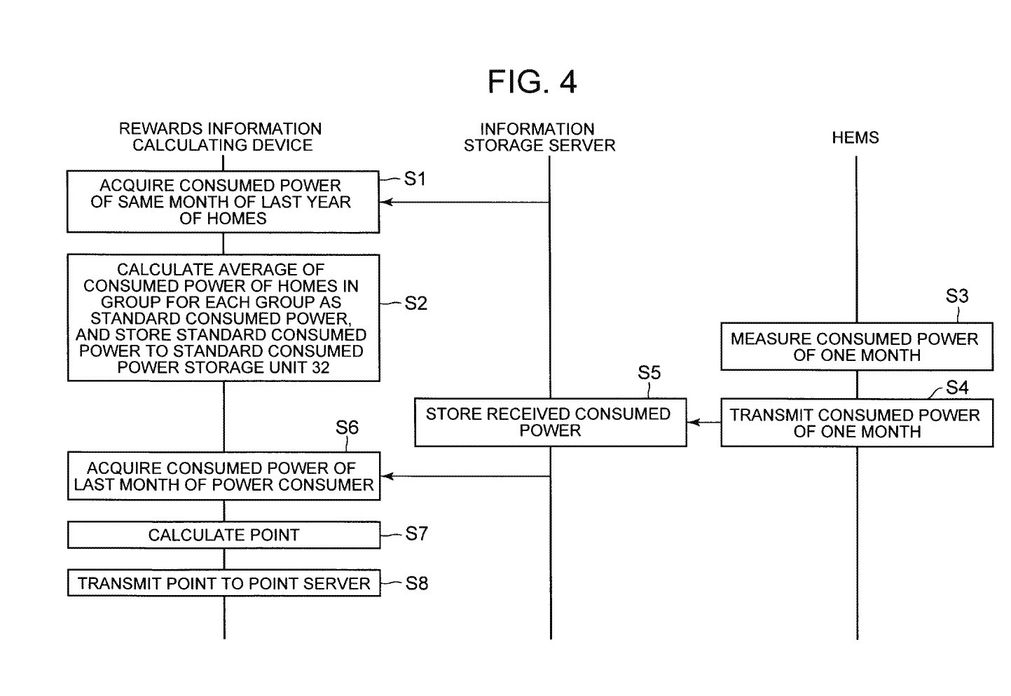

Next, processing progress of the present exemplary embodiment will be described. FIG. 4 is a sequence diagram illustrating an example of the processing progress of the first exemplary embodiment. The administrator of the rewards information calculating system stores the power consumer IDs of the power consumer, the group ID, and the attribute information to the power storage unit 21 of the information storage server 20 in advance. Further, the power storage unit 21 stores, for each power consumer, the information of past consumed power.

The rewards information calculating system performs the following operations for each predetermined period.

The standard consumed power calculating unit 31 of the rewards information calculating device 30 acquires the information of the consumed power of the same month of last year of the homes from the information storage server 20 at the start of a predetermined period (in this example, at the beginning of a month) (step S1). To be specific, the standard consumed power calculating unit 31 requests, for each group, the information storage server 20 to obtain the group ID and the information of the consumed power of the same month of last year of the homes of the power consumers who belong to the group. Upon receipt of the request, the control unit 22 of the information storage server 20 reads, for each group, the group ID and the information of the consumed power of the same month of last year of the homes of the power consumers who belong to the group from the power storage unit 21, and transmits the read group ID and information to the rewards information calculating device 30. The standard consumed power calculating unit 31 then receives the group ID of each group and the information of the consumed power of the same month of last year of the homes of the power consumers who belong to the group from the information storage server 20.

Next, the standard consumed power calculating unit 31 calculates, for each group, an average of the consumed power of the same month of last year of the homes of the power consumers who belong to the group as the standard consumed power. The standard consumed power calculating unit 31 then stores the standard consumed power of each group to the standard consumed power storage unit 32 in association with the group ID (step S2).

Further, the power supply unit 11 of the HEMS 10 receives the supplied power from the power company and supplies the power to the devices (electrical appliances, for example) at home of the power consumer during one month. The power measuring unit 12 then measures the consumed power of one month of the power consumer (the power of one month supplied to the devices at home by the power supply unit 11) (step S3).

The information transmitting unit 13 then transmits the information of the consumed power of one month measured by the power measuring unit 12 to the information storage server 20 together with the power consumer ID at the end of the predetermined period (at the end of the month in this example) (step S4).

Upon receipt of the consumed power of one month and the power consumer ID from the information transmitting unit 13, the control unit 22 stores the consumed power in the power storage unit 21 in association with the power consumer ID, as the consumed power of the appropriate month (step S5).

The rewards information calculating unit 33 of the rewards information calculating device 30 then acquires the power consumer IDs of the power consumers, the group ID, and the consumed power of a recent past predetermined period (the consumed power of last month in this example) from the information storage server 20, for each predetermined period (for example, at the beginning of each month) (step S6). To be specific, the rewards information calculating unit 33 requests, at the beginning of each month, the information storage server 20 to obtain the power consumer IDs of the power consumers, the group ID, and the information of the consumed power of last month. Upon receipt of the request, the control unit 22 of the information storage server 20 reads the requested information from the power storage unit 21, and transmits the read information to the rewards information calculating device 30. The rewards information calculating unit 33 then receives the power consumer IDs of the power consumers, the group ID, and the information of the consumed power of last month from the information storage server 20.

Next, the rewards information calculating unit 33 calculates, for each power consumer, a point that indicates the degree of power saving of last month, based on the consumed power of last month and the standard consumed power of last month (step S7).

The processing of step S7 will be specifically described. The rewards information calculating unit 33 selects one power consumer ID from among the power consumer IDs of the power consumers received in step S6. The rewards information calculating unit 33 reads the standard consumed power of last month in the group ID corresponding to the power consumer ID from the standard consumed power storage unit 32. This standard consumed power is X [kWh]. Further, the consumed power of last month corresponding to the selected power consumer ID is Y [kWh]. The rewards information calculating unit 33 calculates a point (P) of the power consumer indicated by the selected power consumer ID by performing calculation of the formula (1) below:

P=(X−Y)*emission constant*point conversion constant Formula (1)

Note that, when X<Y (that is, when the consumed power exceeds the standard consumed power), the rewards information calculating unit 33 calculates P=0.

The emission constant is a constant for converting the power into a carbon dioxide (CO₂) emission amount. The CO₂ emission amount is obtained by multiplying the power by the emission constant. As the emission constant, for example, 0.375 kg/kWh may be used. Further, the emission constant may be individually set for each power company that supplies the power to the power consumer. In this case, for example, the emission constant is stored in the power storage unit 21 for power consumer ID, and the rewards information calculating unit 33 may just acquire the emission constant of each power consumer ID from the information storage server 20 in step S6.

The point conversion constant is a constant for converting the CO₂ emission amount reduced by the power saving into the point. The point is obtained by multiplying the CO₂ emission amount by the point conversion constant. The point conversion constant may differ for each point server 40. In this case, for example, the point conversion constant corresponding to the point service specified by the power consumer in advance is stored in the power storage unit 21 for each power consumer ID, and the rewards information calculating unit 33 may just acquire the point conversion constant of each power consumer ID from the information storage server 20 in step S6.

When X≧Y, the (X−Y) in the formula (1) indicates how much the power consumption is suppressed based on standard consumed power X. The (X−Y)*emission constant indicates the CO₂ emission amount reduced by the power saving by the power consumer. The formula (1) means that the point is calculated by multiplying the CO₂ emission amount reduced by the power saving by the point conversion constant. The value of the consumed power Y becomes smaller as the degree of power saving by the power consumer is larger. Therefore, the reduction amount of CO₂ emission becomes large (that is, the value of “(X−Y)*emission constant” becomes large), and as a result, the calculated point becomes large.

When having calculated the point regarding the selected power consumer ID, the rewards information calculating unit 33 selects an unselected power consumer ID and similarly calculates the point. The rewards information calculating unit 33 repeats this processing until no unselected power consumer ID exists, and terminates step S7 when no unselected power consumer ID exists.

After step S7, the rewards information calculating unit 33 transmits, for each power consumer ID, the power consumer ID and the point calculated in step S7 regarding the power consumer ID to the point server 40 (step S8). In step S8, the point server 40 serving as a transmission destination of the point is a point server corresponding to the point service specified by the power consumer indicated by the power consumer ID in advance. For example, when a certain power consumer has specified the point service of a certain convenience store, the rewards information calculating unit 33 transmits the power consumer ID of the power consumer and the point to the point server that manages the point in the point service of the convenience store.

The point server 40 accumulates the point every time the power consumer purchases a good or receives an offer of a service from the administrator (for example, the convenience store or an airline company) of the point server 40. Upon receipt the power consumer ID and the point transmitted by the rewards information calculating unit 33 in step S8, the point server 40 then adds the point received from the rewards information calculating unit 33 to a point of the power consumer indicated by the power consumer ID. The power consumer then can receive various services (for example, a discount of a price of the good) from the administrator of the point server 40 with the point stored in the point server 40.

In the above example, a case in which steps S1 and S6 are executed at the beginning of a month, and step S4 is executed at the end of the month has been described. However, timing to execute the processing of steps S1, S4, S6, and the like in a predetermined period is not limited to the above example

Further, in the exemplary embodiment, an example in which the standard consumed power calculating unit 31 calculates the standard consumed power based on the consumed power of the same month of last year has been described. However, the standard consumed power calculating unit 31 may calculate the standard consumed power based on the Yin the formula (1) and the consumed power of the same month of the same year. In this case, the standard consumed power calculating unit 31 acquires the information of the consumed power of last month of the homes from the information storage server 20 after step S5 (for example, at the beginning of a month), instead of steps S1 and S2. This operation is similar to the operation of step S1, except that an object to be acquired is the information of the consumed power of last month. The standard consumed power calculating unit 31 then calculates, for each group, an average of the consumed power of last month of the homes of the power consumers who belong to the group, as the standard consumed power. The standard consumed power calculating unit 31 then stores the standard consumed power of each group to the standard consumed power storage unit 32 in association with the group ID. The point to calculate the standard consumed power based on the Y (see the formula (1)) and the consumed power of the same month of the same year is similar in a second exemplary embodiment below.

According to the present exemplary embodiment, the point accumulated by the point server 40 is increased not only when the power consumer purchases a good or receives an offer of a service from the administrator of the point server 40, but also when the power consumer performs the power saving. Then, the point to be added becomes larger as the degree of power saving is larger, and the power consumer can receive more services from the administrator of the point server 40. Therefore, an incentive of the power saving can be provided to the power consumer. Further, the point according to the degree of power saving is calculated for each predetermined period, and thus the incentive of the power saving can be continuously provided to the power consumer. As a result, the present invention can contribute to realization of a low-carbon society (a society with less CO₂ emission).

Further, in the present exemplary embodiment, the homes of the power consumers are divided into groups such that the homes of the power consumers having the same attribute information belong to the same group. Then, the standard consumed power is calculated for each group. The rewards information calculating unit 33 calculates the point to be provided to each power consumer, based on a difference between the standard consumed power of the group to which the home of the power consumer belongs and the consumed power at home. Therefore, the point can be calculated without causing unfairness to the power consumer.

For example, as described above, tendencies of the power consumption differ between the power consumers who live in places in different climates. In the present exemplary embodiment, the power consumers who live in places in different climates belong to separate groups from each other, and the point is calculated using the standard consumed power calculated for each group. That is, the point is calculated according to different criteria for each group. Therefore, even if the tendencies of the power consumption differ, the unfairness may not be caused among the power consumers.

Further, in the present exemplary embodiment, the rewards information calculating unit 33 calculates the point without using the ranking of the power saving of the power consumers. Therefore, an effect not to cause the unfairness among the power consumers can be enhanced. For example, the degrees of the power saving of the power consumers in the same rank in a certain group A and a separate group B do not necessarily accord with each other. Therefore, when the point is provided based on the ranking of the power saving, the unfairness may be caused. In the present exemplary embodiment, the rewards information calculating unit 33 calculates the point without using the ranking of the power saving, so that occurrence of such unfairness is prevented.

Further, the rewards information calculating unit 33 calculates the point by multiplying the CO₂ emission amount (that is, “(X−Y)*emission constant” in the formula (1)) reduced by the power saving by the point conversion constant. Then, the administrator of the point server 40 provides more services to the power consumer according to the addition of the point. Therefore, in transaction of the CO₂ emission amount, the administrator of the point server 40 can be regarded to reduce the CO₂ emission amount by the point calculated by the rewards information calculating unit 33.

Note that the rewards information calculating unit 33 may calculate the point by using a point conversion constant for directly converting the (X−Y) into the point, without using the emission constant and the point conversion constant illustrated in the formula (1), and multiplying the (X−Y) by the point conversion constant.

### Exemplary Embodiment 2

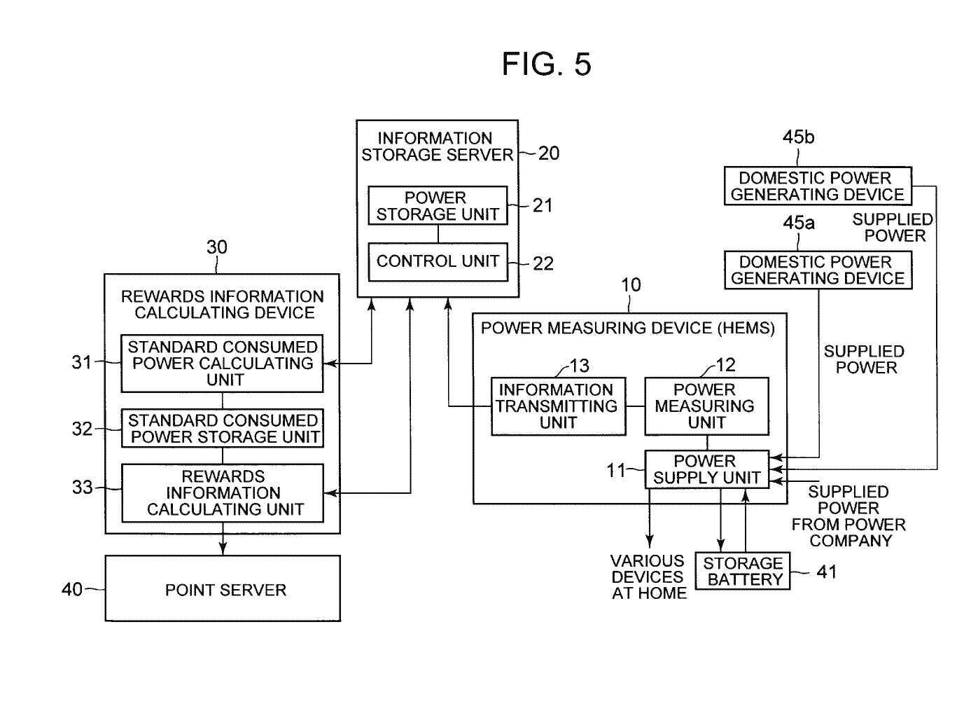

FIG. 5 is a block diagram illustrating an example of a rewards information calculating system of a second exemplary embodiment of the present invention. The rewards information calculating system of the second exemplary embodiment includes similar configuration elements to the rewards information calculating system of the first exemplary embodiment. However, a part of operations of the configuration elements of the rewards information calculating system of the second exemplary embodiment is different from that of the first exemplary embodiment. Hereinafter, the configuration elements of the rewards information calculating system of the second exemplary embodiment will be described, mainly about the point different from the first exemplary embodiment.

Further, in the second exemplary embodiment described below, a case of providing domestic power generating devices 45a and 45b, and a storage battery 41 at home of a power consumer will be exemplarily described.

The domestic power generating devices 45a and 45b are household power generating devices having a smaller emission constant of CO₂ than an emission constant of CO₂ (an emission constant in a time zone other than nighttime) of when a power company supplies power. An example of such household power generating devices includes a household power generating device that generates power by renewable energy. Further, an example of the household power generating device that generates power by renewable energy includes a household photovoltaic power generating device. Since the household photovoltaic power generating device and the like do not generate CO₂, the emission constant of CO₂ is 0. Hereinafter, the domestic power generating device 45a does not generate CO₂ (that is, the emission constant of CO₂ is 0). Further, the domestic power generating device 45b generates CO₂ at the time of generating power, and the emission constant of CO₂ of the domestic power generating device 45b is a larger value than 0. An example of such a domestic power generating device includes a household fuel-cell cogeneration system. The domestic power generating devices 45a and 45b supply the generated power to a power supply unit 11 of a HEMS 10.

In the present exemplary embodiment, a case of providing the domestic power generating devices 45a and 45b at home of the power consumer has been exemplarily described. However, only one of the domestic power generating devices 45a and 45b may be provided at home of the power consumer.

Further, in the present exemplary embodiment, the emission constant of CO₂ of when the power company supplies power differs between in the nighttime and in the time zone other than the nighttime. Then, in the nighttime, the ratio of thermal power generation is low, and the emission constant of the power company in the nighttime is a smaller value than the emission constant of the power company in the time zone other than the nighttime. Further, the nighttime can be said to be a time zone having a relatively low power purchase price.

The storage battery 41 is a storable battery, and supplies power to the power supply unit 11.

The power measuring device (HEMS) 10 in the second exemplary embodiment will be described.

In the second exemplary embodiment, the power supply unit 11 receives supplied power not only from the power company but also from the domestic power generating devices 45a and 45b. The power supply unit 11 then preferentially supplies the supplied power from the domestic power generating devices 45a and 45b to devices at home of the power consumer. Further, when the supplied power from the domestic power generating devices 45a and 45b exceeds the power consumed in the devices at home at points of time in a predetermined period, the power supply unit 11 stores a surplus power of the supplied power from the domestic power generating devices 45a and 45b to the storage battery 41. The power supply unit 11 may store the surplus power of the supplied power from the domestic power generating devices 45a and 45b to the storage battery 41, and sell the surplus power to the power company. Further, the power supply unit 11 also receives power supply from the storage battery 41 after the storage, and supplies the power to the devices at home. Note that, in the present exemplary embodiment, the time zone in which the storage battery 41 supplies the power to the devices at home is determined to a time zone other than the nighttime. Further, the time corresponding to the nighttime is determined in advance.

A power measuring unit 12 measures, for each predetermined period, consumed power of the home of the power consumer in the predetermined period (that is, power supplied by the power supply unit 11 to the devices at home). This point is similar to the first exemplary embodiment. Further, the power measuring unit 12 measures, for each predetermined period, power supplied to the devices at home of the power generated by the domestic power generating devices 45a and 45b (the power is written as self-consumed power), and power stored in the storage battery 41 of the power generated by the domestic power generating devices 45a and 45b (hereinafter, the power is stored power) in the predetermined period. Note that the sold power does not correspond to the power supplied to the devices at home, and thus is not included in the self-consumed power. Further, the power once stored in the storage battery 41 of the power generated by the domestic power generating devices 45a and 45b is also not included in the self-consumed power. Further, the self-consumed power corresponds to a part of the consumed power.

Hereinafter, the power supplied to the devices at home of the power generated by the domestic power generating device 45a is written as self-consumed power based on the domestic power generating device 45a. The power supplied to the devices at home of the power generated by the domestic power generating device 45b is written as self-consumed power based on the domestic power generating device 45b. Further, the power stored in the storage battery 41 of the power generated by the domestic power generating device 45a is written as stored power based on the domestic power generating device 45a. Further, the power stored in the storage battery 41 of the power generated by the domestic power generating device 45b is written as stored power based on the domestic power generating device 45b.

Further, the power supply unit 11 stores power to the storage battery 41 with the power supplied from the power company. Note that the time zone in which the power supply unit 11 stores power to the storage battery 41 with the power supplied from the power company is limited to the nighttime. Note that the time zone in which the power supply unit 11 stores power to the storage battery 41 with the supplied power from the domestic power generating devices 45a and 45b may not be limited to the nighttime. Further, as described above, the time zone in which the storage battery 41 supplies the power to the devices at home is a time zone other than the nighttime. The power stored by the power supply unit 11 to the storage battery 41 with the power supplied from the power company is written as nighttime stored power. The power measuring unit 12 also measures, for each predetermined period, the nighttime stored power in the predetermined period.

Further, the power measuring unit 12 also measures, for each predetermined period, power supplied from the power company in the nighttime and supplied to the devices at home without being stored (hereinafter, the power is also written as nighttime used power).

A case in which the predetermined period is one month will be exemplarily described even in the second exemplary embodiment.

An information transmitting unit 13 transmits, to an information storage server 20, information of consumed power of one month at home of the power consumer, the self-consumed power based on the domestic power generating device 45a, the stored power based on the domestic power generating device 45a, the self-consumed power based on the domestic power generating device 45b, the stored power based on the domestic power generating device 45b, the nighttime used power, and the nighttime stored power.

The information storage server 20 in the second exemplary embodiment will be described.

A control unit 22 is similar to that of the first exemplary embodiment. However, the control unit 22 of the present exemplary embodiment receives the information of the consumed power, the self-consumed power based on the domestic power generating device 45a, the stored power based on the domestic power generating device 45a, the self-consumed power based on the domestic power generating device 45b, the stored power based on the domestic power generating device 45b, the nighttime used power, and the nighttime stored power from the information transmitting unit 13, and stores the information to a power storage unit 21.

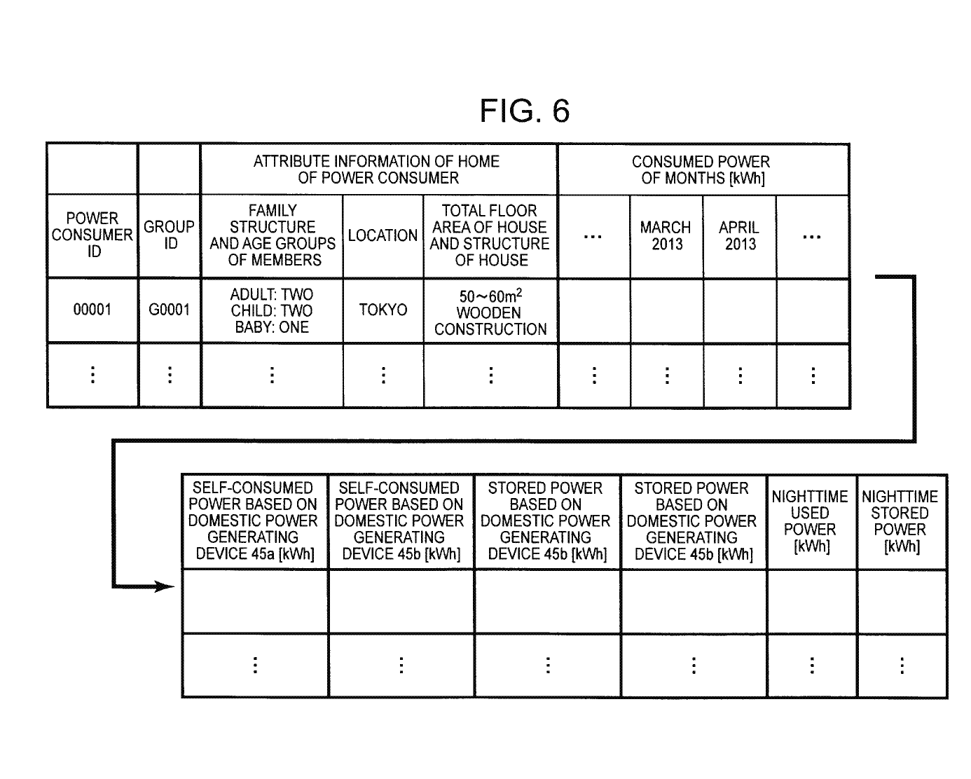

FIG. 6 is an explanatory diagram schematically illustrating an example of the information stored in the power storage unit 21 in the second exemplary embodiment. As illustrated in FIG. 6, the power storage unit 21 also stores, for each power consumer, the self-consumed power based on the domestic power generating device 45a of each one month, the self-consumed power based on the domestic power generating device 45b of each one month, the stored power based on the domestic power generating device 45a of each one month, the stored power based on the domestic power generating device 45b of each one month, the nighttime used power of each one month, and the nighttime stored power of each one month, in addition to the information stored in the first exemplary embodiment.

A rewards information calculating device 30 in the second exemplary embodiment will be described.

A standard consumed power calculating unit 31 and a standard consumed power storage unit 32 are similar to the standard consumed power calculating unit 31 and the standard consumed power storage unit 32 in the first exemplary embodiment, respectively.

A rewards information calculating unit 33 acquires, for each predetermined period (one month in this example), from the information storage server 20, power consumer IDs of power consumers, a group ID, and information of the consumed power of one month, the self-consumed power based on the domestic power generating device 45a of one month, the self-consumed power based on the domestic power generating device 45b of one month, the stored power based on the domestic power generating device 45a of one month, the stored power based on the domestic power generating device 45b of one month, the nighttime used power of one month, and the nighttime stored power of one month. The rewards information calculating unit 33 then calculates, for each power consumer, a point of the power consumer of one month based on standard consumed power of a group to which the home of the power consumer belongs, the consumed power, the self-consumed power based on the domestic power generating device 45a, the self-consumed power based on the domestic power generating device 45b, the stored power based on the domestic power generating device 45a, the stored power based on the domestic power generating device 45b, the nighttime used power, and the nighttime stored power, and transmits the point to a point server 40.

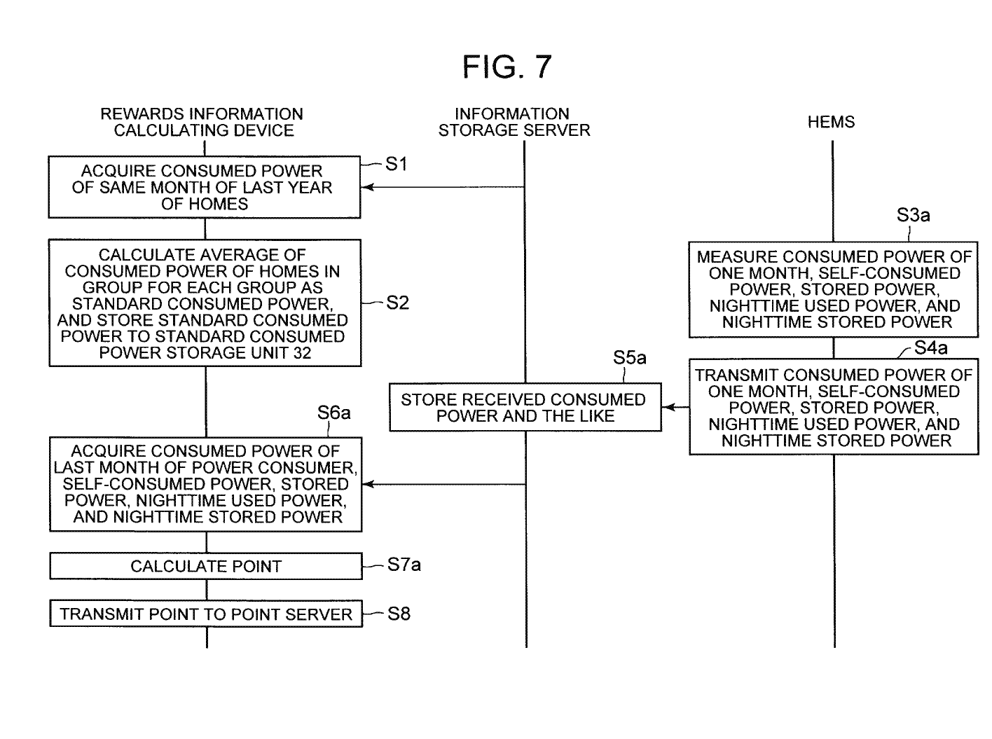

Next, processing progress of the present exemplary embodiment will be described. FIG. 7 is a sequence diagram illustrating an example of processing progress of the second exemplary embodiment. Operations similar to the first exemplary embodiment are denoted with the same reference signs as FIG. 4, and description is omitted.

Operations of steps S1 and S2 are similar to those in the first exemplary embodiment.

During one month, the power supply unit 11 of the HEMS 10 receives the supplied power from the domestic power generating devices 45a and 45b, the supplied power from the storage battery 41, and the supplied power from the power company, and supplies the power to the devices at home of the power consumer. At this time, the power supply unit 11 preferentially supplies the supplied power from the domestic power generating devices 45a and 45b to the devices at home. As described above, when the supplied power from the domestic power generating devices 45a and 45b exceeds the power consumed in the devices at home, the power supply unit 11 stores the surplus power of the supplied power from the domestic power generating devices 45a and 45b to the storage battery 41. The power supply unit 11 may store the surplus power of the supplied power from the domestic power generating devices 45a and 45b to the storage battery 41, and sell the surplus power to the power company. Further, the power supply unit 11 stores the power storable in the storage battery 41 of the power supplied from the power company in the nighttime to the storage battery 41.

The power measuring unit 12 then measures the consumed power of one month of the power consumer (the power of one month supplied by the power supply unit 11 to the devices at home), the self-consumed power based on the domestic power generating device 45a of one month, the self-consumed power based on the domestic power generating device 45b of one month, the stored power based on the domestic power generating device 45a of one month, the stored power based on the domestic power generating device 45b of one month, the nighttime used power of one month, and the nighttime stored power of one month (step S3a).

Note that the storage battery 41 may not be provided at home of the power consumer. In that case, the power measuring unit 12 sets the stored power based on the domestic power generating device 45a of each month, the stored power based on the domestic power generating device 45b of each month, and the nighttime stored power of each month to 0.

Further, the domestic power generating device 45a (a domestic power generating device that does not generate CO₂, for example, a household photovoltaic power generating device) may not be provided at home of the power consumer. In that case, the power measuring unit 12 sets the self-consumed power based on the domestic power generating device 45a of each month and the stored power based on the domestic power generating device 45a of each month to 0.

Further, the domestic power generating device 45b (a domestic power generating device associated with generation of CO₂, for example, a household fuel cell cogeneration system) may not be provided at home of the power consumer. In that case, the power measuring unit 12 sets the self-consumed power based on the domestic power generating device 45b of each month and the stored power based on the domestic power generating device 45b of each month to 0.

The information transmitting unit 13 then transmits, to the information storage server 20, the information of the consumed power of one month, the self-consumed power based on the domestic power generating device 45a of one month, the self-consumed power based on the domestic power generating device 45b of one month, the stored power based on the domestic power generating device 45a of one month, the stored power based on the domestic power generating device 45b of one month, the nighttime used power of one month, and the nighttime stored power of one month, which have been measured by the power measuring unit 12, together with the power consumer ID, at the end of the predetermined period (at the end of the month in this example) (step S4a).

The control unit 22 receives, from the information transmitting unit 13, the information of the consumed power of one month, the self-consumed power based on the domestic power generating device 45a of one month, the self-consumed power based on the domestic power generating device 45b of one month, the stored power based on the domestic power generating device 45a of one month, the stored power based on the domestic power generating device 45b of one month, the nighttime used power of one month, and the nighttime stored power of one month, and the power consumer ID. The control unit 22 then stores, to the power storage unit 21, the information of the consumed power of one month, the self-consumed power based on the domestic power generating device 45a of one month, the self-consumed power based on the domestic power generating device 45b of one month, the stored power based on the domestic power generating device 45a of one month, the stored power based on the domestic power generating device 45b of one month, the nighttime used power of one month, and the nighttime stored power of one month, in association with the power consumer ID, as the consumed power of the appropriate month, the self-consumed power based on the domestic power generating device 45a, the self-consumed power based on the domestic power generating device 45b, the stored power based on the domestic power generating device 45a, the stored power based on the domestic power generating device 45b, the nighttime used power, and the nighttime stored power (step S5a).

Then, the rewards information calculating unit 33 of the rewards information calculating device 30 acquires, for each predetermined period (for example, at the beginning of each month), the power consumer IDs of the power consumers, the group ID, the information of the consumed power of a recent past predetermined period, the self-consumed power based on the domestic power generating device 45a, the self-consumed power based on the domestic power generating device 45b, the stored power based on the domestic power generating device 45a, the stored power based on the domestic power generating device 45b, the nighttime used power, and the nighttime stored power from the information storage server 20 (step S6a). In this example, the recent past predetermined period means last month. The rewards information calculating unit 33 requests the information storage server 20 to acquire the information of last month. Upon receipt of the request, the control unit 22 of the information storage server 20 reads the requested information from the power storage unit 21, and transmits the read information to the rewards information calculating device 30. The rewards information calculating unit 33 then receives, from the information storage server 20, the information of the power consumer IDs of the power consumers, the group ID, the consumed power of last month, the self-consumed power based on the domestic power generating device 45a of last month, the self-consumed power based on the domestic power generating device 45b of last month, the stored power based on the domestic power generating device 45a of last month, the stored power based on the domestic power generating device 45b of last month, the nighttime used power of last month, and the nighttime stored power of last month.

Next, the rewards information calculating unit 33 calculates, for each power consumer, a point that indicates the degree of power saving of last month, based on the consumed power of last month, the self-consumed power based on the domestic power generating device 45a of last month, the self-consumed power based on the domestic power generating device 45b of last month, the stored power based on the domestic power generating device 45a of last month, the stored power based on the domestic power generating device 45b of last month, the nighttime used power of last month, the nighttime stored power of last month, and the standard consumed power of last month (step S7a).

The processing of step S7a will be specifically described. The rewards information calculating unit 33 selects one power consumer ID from among the power consumer IDs of the power consumers received in step S6a. The rewards information calculating unit 33 reads the standard consumed power of last month in the group ID corresponding to the power consumer ID from the standard consumed power storage unit 32. This standard consumed power is X [kWh]. Further, the consumed power of last month corresponding to the selected power consumer ID is Y [kWh]. Further, the self-consumed power based on the domestic power generating device 45a of last month corresponding to the selected power consumer ID is Z₁ [kWh]. Further, the stored power based on the domestic power generating device 45a of last month corresponding to the selected power consumer ID is Z₂ [kWh]. Further, the self-consumed power based on the domestic power generating device 45b of last month corresponding to the selected power consumer ID is W₁ [kWh]. The stored power based on the domestic power generating device 45b of last month corresponding to the selected power consumer ID is W₂ [kWh]. Further, the nighttime used power of last month corresponding to the selected power consumer ID is V₁ [kWh]. The nighttime stored power of last month corresponding to the selected power consumer ID is V₂ [kWh]. The rewards information calculating unit 33 calculates a point P of the power consumer indicated by the selected power consumer ID by performing calculation of the formula (2) below:

P=((X−Y)*emission constant A+(Z₁+Z₂)*emission constant A+(W₁+W₂)*(emission constant A−emission constant B)+(V₁+V₂)*(emission constant A−emission constant C))*point conversion constant Formula (2)

Note that, when a calculation result of the formula (2) is negative, the rewards information calculating unit 33 sets P=0.

The point conversion constant is similar to the point conversion constant in the first exemplary embodiment, and description is omitted.

Further, the emission constant A is an emission constant of CO₂ of the power company in the time zone other than the nighttime. The emission constant B is an emission constant of CO₂ of the domestic power generating device 45b. The emission constant C is an emission constant of CO₂ of the power company in the nighttime. For example, the emission constants A, B, and C are stored in the power storage unit 21 for each power consumer ID, and the rewards information calculating unit 33 may just acquire the emission constants A, B, and C of each power consumer ID from the information storage server 20 in step S6a.

The (X−Y) in the formula (2) is similar to the (X−Y) in the formula (1), and the (X−Y)*emission constant A represents a CO₂ emission amount reduced by the power saving of the consumer.

Further, the (Z₁+Z₂) is power obtained by the domestic power generating device 45a without accompanying generation of CO₂. Therefore, the (Z₁+Z₂)*emission constant A represents the CO₂ emission amount reduced by using the domestic power generating device 45a and the storage battery 41.

Further, the (W₁+W₂) is power obtained by the domestic power generating device 45b. Therefore, the (W₁+W₂)*(emission constant A−emission constant B) represents the CO₂ emission amount reduced by using the domestic power generating device 45b and the storage battery 41.

Further, the (V₁+V₂) represents a use amount of the power generated by the power company in the nighttime. In the nighttime, the ratio of thermal power generation is lower than the time zone other than the nighttime, and the CO₂ emission amount can be reduced by using the power generated in the nighttime. Therefore, the (V₁+V₂)*(emission constant A−emission constant C) represents the CO₂ emission amount reduced by using the power generated in the nighttime.

The formula (2) means that the point is calculated by multiplying a sum of the CO₂ reduction amounts by the point conversion constant. The value of the consumed power Y becomes smaller as the degree of the power saving by the power consumer is larger. Further, the value of Z₁ becomes larger as the domestic power generating device 45a is more used, and the value of W₁ becomes larger as the domestic power generating device 45b is more used. Further, the values of Z₂, W₂, and V₂ become larger as the storage battery 41 is more used. Further, when the same power is used, a reduction effect of CO₂ emission is larger when the power is used in the nighttime. Therefore, as the degree of the power saving by the power consumer is larger, the degree of power saving using the domestic power generating devices 45a and 45b and the storage battery 41 is larger, and the degree of using the power generated by the power company in the nighttime is larger, the reduction amount of CO₂ emission becomes larger. As a result, the point calculated by the formula (2) becomes large.

When having calculated the point regarding the selected power consumer ID, the rewards information calculating unit 33 selects an unselected power consumer ID and similarly calculates the point. The rewards information calculating unit 33 repeats this processing until no unselected power consumer ID exists, and terminates step S7a when no unselected power consumer ID exists.

After step S7a, the rewards information calculating unit 33 transmits, for each power consumer ID, the power consumer ID and the point calculated in step S7a regarding the power consumer ID to the point server 40 (step S8). Step S8 is similar to step S8 in the first exemplary embodiment. Further, the operation of the point server 40 that has received the point from the rewards information calculating unit 33 is also similar to the operation of the point server 40 in the first exemplary embodiment.

The rewards information calculating system performs the above operations for each predetermined period.

Note that, in the above example, a case in which steps S1 and S6a are executed at the beginning of a month, and step S4a is executed at the end of the month has been described. However, timing to execute the processing of steps S1, S4a, S6a, and the like in the predetermined period is not limited to the example.

Even in the second exemplary embodiment, an effect similar to the first exemplary embodiment can be obtained. Further, in the second exemplary embodiment, the value of the point calculated in step S7a becomes larger as the degree of power saving using the domestic power generating devices 45a and 45b and the storage battery 41 is larger. Therefore, not only an incentive of the power saving by an effort of the power consumer himself/herself, but also an incentive of the power saving using the domestic power generating devices 45a and 45b and the storage battery 41 can be provided to the power consumer. For example, an incentive to use the domestic power generating devices 45a and 45b and the storage battery 41 is provided to the power consumer who does not own the domestic power generating devices 45a and 45b, and the storage battery 41, and the spread of these facilities is encouraged and the power saving effect can be further enhanced.

Further, in the above example, the calculated point becomes larger as the nighttime used power V₁ and the nighttime stored power V₂ are larger. Therefore, an incentive to contribute to suppression of the power generation in the power company in the time zone other than the nighttime can be provided to the power consumer.

Note that the rewards information calculating unit 33 may calculate the point by calculating the following formula (3) without using the emission constant and the point conversion constant illustrated in the formula (2).

P=((X−Y)+(Z₁+Z₂)+(W₁+W₂)+(V₁+V₂))*point conversion constant Formula (3)

That is, the rewards information calculating unit 33 may directly calculate the point without obtaining the CO₂ reduction amount.

In the second exemplary embodiment, when the rewards information calculating unit 33 calculates the points of the power consumers, the rewards information calculating unit 33 may calculate the points without using the stored power in the same way regardless of whether the individual power consumers own the storage battery 41. In this case, Z₂=W₂=0 may just be employed in the formulas (2) and (3).

In this case, the power measuring unit 12 may not measure the stored power based on the domestic power generating device 45a of one month and the stored power based on the domestic power generating device 45b of one month in step S3a. As a result, the information transmitting unit 13 may not transmit the information of the stored power based on the domestic power generating device 45a of one month and the stored power based on the domestic power generating device 45b of one month to the information storage server 20 in step S4a. Further, the control unit 22 may not store the information of the stored power based on the domestic power generating device 45a of one month and the stored power based on the domestic power generating device 45b of one month to the power storage unit 21 in step S5a. Further, the rewards information calculating unit 33 may not acquire the information of the stored power based on the domestic power generating device 45a of one month and the stored power based on the domestic power generating device 45b of one month from the information storage server 20 in step S6a. Even in this case, the incentive of the power saving using the domestic power generating devices 45a and 45b can be provided to the power consumer.

Further, the rewards information calculating unit 33 may calculate the points without using the nighttime stored power in the same way regardless of whether the individual power consumers own the storage battery 41. In this case, V₂=0 may just be employed in the formulas (2) and (3). Further, in this case, measurement of the nighttime stored power, transmission of the nighttime stored power to the information storage server 20, and the like may not be performed. Then, in this case, the time zone in which the storage battery 41 supplies the power may not be especially limited. Further, the rewards information calculating unit 33 may calculate the points without using the nighttime used power. In this case, V₁=0 may just be employed in the formulas (2) and (3). Further, in this case, measurement of the nighttime used power, transmission of the nighttime used power to the information storage server 20, and the like may not be performed. Even in these cases, the incentive of the power saving using the domestic power generating devices 45a and 45b can be provided to the power consumer.

Further, the rewards information calculating unit 33 may calculate the points without using the self-consumed power in the same way regardless of whether the individual power consumers own the domestic power generating device 45a and the domestic power generating device 45b. In this case, Z₁=W₁=0 may just be employed in the formulas (2) and (3). In this case, measurement of the self-consumed power based on the domestic power generating device 45a and the self-consumed power based on the domestic power generating device 45b, transmission of the self-consumed power to the information storage server 20, and the like may not be performed. Even in this case, the incentive of the power saving using the storage battery 41 can be provided to the power consumer.

In the first and second exemplary embodiments, a case in which the standard consumed power calculating unit 31 calculates, for each group, the average of the consumed power of the same month of last year (or the same month of the same year) as the standard consumed power has been described. In this case, the standard consumed power calculating unit 31 calculates the standard consumed power every month. A period for which the standard consumed power is calculated is not limited to this example. For example, the standard consumed power calculating unit 31 may calculate the standard consumed power of a period (for example, five years) longer than the period (one month in the above example) of which the point of the power consumer is calculated by the rewards information calculating unit 33. Alternatively, the standard consumed power calculating unit 31 may not update the standard consumed power of each group after calculating the standard consumed power once for each group. However, the way of calculating the standard consumed power in a relatively short period such as one month can more easily handle change of a tendency of the consumed power.

Further, in the first and second exemplary embodiments, an example in which the attribute information of the homes of the power consumers is transmitted from the individual power consumers to the administrator of the rewards information calculating system in advance, and the administrator stores the attribute information to the power storage unit 21 has been described. The information storage server 20 may acquire necessary information for estimation of the attribute information from the HEMS 10 beforehand, estimate the attribute information based on the information, and store the attribute information to the power storage unit 21. After that, the administrator of the rewards information calculating system or the like may perform grouping of the homes of the power consumers based on the attribute information.

Next, modifications of the exemplary embodiments will be described.

In the exemplary embodiments, a rewards information calculating unit 33 may calculate a larger point to a power consumer as a period in which the power consumer receives a point calculated by the rewards information calculating unit 33 is longer. That is, the rewards information calculating unit 33 may add a point to the point calculated in the exemplary embodiments as the period in which the power consumer receives the point calculated by the rewards information calculating unit 33 is longer.

Further, when the power consumer owns facilities for power saving such as domestic power generating devices 45a and 45b and a storage battery 41, the rewards information calculating unit 33 may calculate a larger point to the power consumer. That is, when the power consumer owns the facilities such as the domestic power generating devices 45a and 45b and the storage battery 41, the rewards information calculating unit 33 may further add a point according to these facilities, in addition to the point calculated in the exemplary embodiments.

Further, when consumed power of the power consumer is smaller than consumed power of the same month of last year of the power consumer, the rewards information calculating unit 33 may calculate a larger point to the power consumer. That is, when the consumed power of the power consumer is smaller than the consumed power of the same month of last year of the power consumer, the rewards information calculating unit 33 may further add a predetermined point, in addition to the point calculated in the exemplary embodiments.

Further, in the exemplary embodiments, a case in which the rewards information calculating unit 33 transmits the point of the power consumer to the point server 40 corresponding to the point service specified by the power consumer in advance has been described. The rewards information calculating unit 33 may transmit, to a terminal (not illustrated) of the power consumer, information that recommends point addition to a specific point service of point services that the power consumer has already received. Upon receipt of information indicating receiving of the recommendation from the terminal of the power consumer, the rewards information calculating unit 33 may then transmit the point of the power consumer to the point server 40 corresponding to the recommended point service.

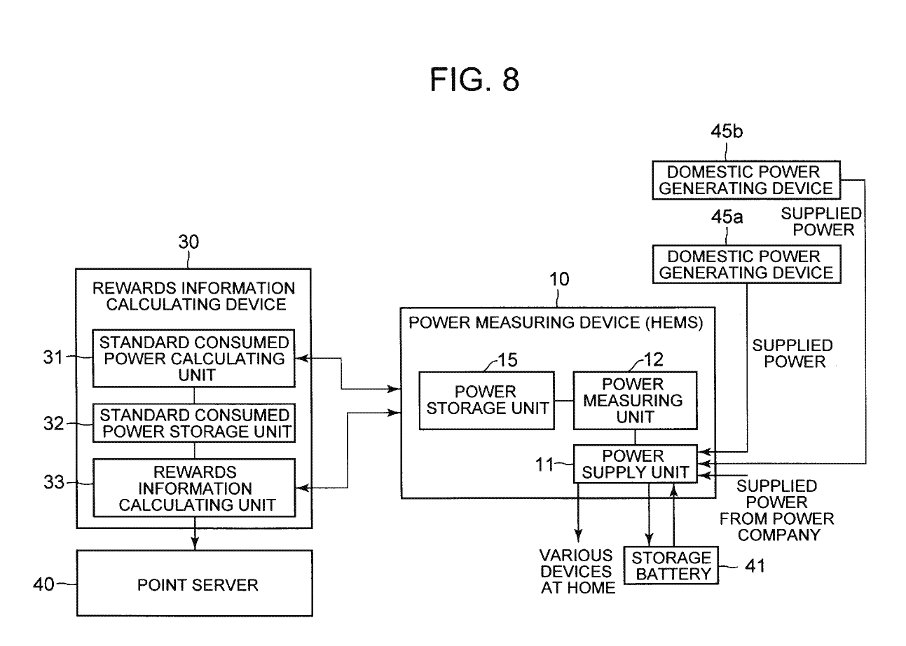

Further, in the exemplary embodiments, a case in which a power storage unit 21 of an information storage server 20 stores the power consumer IDs, the group ID, the attribute information of the homes of the power consumers, and the information received from the HEMS 10 has been described. Each of HEMSs 10 may have a configuration to store power consumer IDs of power consumers who own the HEMSs 10, a group ID, attribute information of homes of the power consumers, and information of power. FIG. 8 is a block diagram illustrating a configuration example of a case where the HEMS 10 stores the information. In FIG. 8, elements similar to the elements illustrated in FIG. 5 are denoted with the same reference signs as FIG. 5, and description is omitted. Further, in FIG. 8 and the description below, a modification of the second exemplary embodiment is illustrated and described. However, the present modification can be applied to the first exemplary embodiment. In the configuration exemplarily illustrated in FIG. 8, the HEMS 10 includes a power storage unit 15. The power storage unit 15 stores information of one power consumer of the information illustrated in FIG. 6. That is, the power storage unit 15 stores the power consumer IDs of the power consumers who owns the HEMS 10, the group ID, information of consumed power of each month, self-consumed power based on a domestic power generating device 45a of one month, self-consumed power based on a domestic power generating device 45b of one month, stored power based on the domestic power generating device 45a of one month, stored power based on the domestic power generating device 45b of one month, nighttime used power of one month, and nighttime stored power of one month. A power measuring unit 12 may just store the information of the consumed power of one month, the self-consumed power based on the domestic power generating device 45a of one month, the self-consumed power based on the domestic power generating device 45b of one month, the stored power based on the domestic power generating device 45a of one month, the stored power based on the domestic power generating device 45b of one month, the nighttime used power of one month, and the nighttime stored power of one month to the power storage unit 15, instead of step S4a (see FIG. 7). Each of the HEMSs 10 of the power consumers stores the information of various types of power. Further, a standard consumed power calculating unit 31 may just acquire, from the individual HEMSs 10, the group ID and information of consumed power of the same month of last year, and classify the information of the consumed power for each group ID, in step S1, instead of acquiring the information from an information storage server 20. Further, the rewards information calculating unit 33 may just acquire, from the individual HEMSs 10, the power consumer IDs, the group ID, information of consumed power of a recent past predetermined period, the self-consumed power based on the domestic power generating device 45a, the self-consumed power based on the domestic power generating device 45b, the stored power based on the domestic power generating device 45a, the stored power based on the domestic power generating device 45b, the nighttime used power, and the nighttime stored power, in step S6a, instead of acquiring the information from the information storage server 20. Other points are similar to the already described operations.

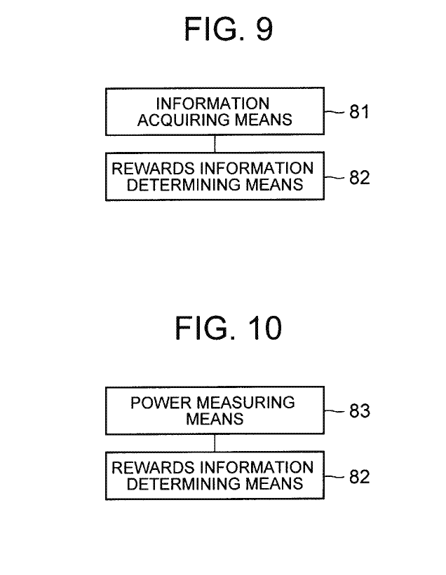

Next, principal portions of the present invention will be described. FIG. 9 is a block diagram illustrating principal portions of a rewards information determining device of the present invention. The rewards information determining device of the present invention includes information acquiring means 81 and rewards information determining means 82.

The information acquiring means 81 (for example, the rewards information calculating unit 33 that executes steps S6 and S6a) acquires information of first consumed power consumed by the power consumer.

The rewards information determining means 82 (for example, the rewards information calculating unit 33 that executes steps S7 and S7a) determines rewards information of the power consumer based on the information of the standard consumed power of the group to which the power consumer belongs, and the information of first consumed power.

With such a rewards information determining device, the rewards information of the power consumer can be determined without causing unfairness to the power consumer.

FIG. 10 is a block diagram illustrating principal portions of a rewards information determining system of the present invention. The rewards information determining system of the present invention includes power measuring means 83 and rewards information determining means 82. The rewards information determining means 82 is similar to the rewards information determining means 82 illustrated in FIG. 9.

The power measuring means 83 (for example, the power measuring unit 12) measures the information of first consumed power consumed by the power consumer.

With such a rewards information determining system, the rewards information of the power consumer can be determined without causing unfairness to the power consumer.

A part or all of the above-described exemplary embodiments can be, but not limited to, described as following supplementary notes.

### (Supplementary Note 1)

A rewards information determining device including: information acquiring means configured to acquire information of first consumed power consumed by a power consumer; and rewards information determining means configured to determine rewards information of the power consumer based on information of standard consumed power of a group to which the power consumer belongs, and the information of first consumed power.

### (Supplementary Note 2)

The rewards information determining device according to Supplementary note 1, wherein the information acquiring means acquires the information of first consumed power, and information of second consumed power (for example, self-consumed power) generated by a power generating facility of the power consumer and consumed by the power consumer, and the rewards information determining means determines the rewards information of the power consumer based on the information of standard consumed power of a group to which the power consumer belongs, the information of first consumed power, and the information of second consumed power.

### (Supplementary Note 3)

The rewards information determining device according to Supplementary note 1, wherein the information acquiring means acquires the information of first consumed power, and information of first stored power generated by a power generating facility of the power consumer and stored in a storage battery, and the rewards information determining means determines the rewards information of the power consumer based on the information of standard consumed power of a group to which the power consumer belongs, the information of first consumed power, and the information of first stored power.

### (Supplementary Note 4)

The rewards information determining device according to Supplementary note 2, wherein the information acquiring means acquires the information of first consumed power and the information of second consumed power, and information of first stored power generated by the power generating facility of the power consumer and stored in a storage battery, and the rewards information determining means determines the rewards information of the power consumer based on the information of standard consumed power of a group to which the power consumer belongs, the information of first consumed power, the information of second consumed power, and the information of first stored power.

### (Supplementary Note 5)

The rewards information determining device according to Supplementary note 3 or 4, wherein the information acquiring means acquires information of power stored in the storage battery, of surplus power of when supplied power from the power generating facility of the power consumer exceeds power consumed in devices of the power consumer, as the information of first stored power.

### (Supplementary Note 6)

The rewards information determining device according to any one of Supplementary notes 2 to 5, wherein

the information acquiring means acquires information of power generated by a power generating facility of the power consumer having a smaller emission constant of carbon dioxide than an emission constant of carbon dioxide of a power company, and consumed by the power consumer, as the information of second consumed power.

### (Supplementary Note 7)

The rewards information determining device according to Supplementary note 1, wherein the information acquiring means acquires the information of first consumed power, and information of second stored power (for example, nighttime stored power) stored in a storage battery with power supplied in a time zone where a power purchase price is relatively low, and the rewards information determining means determines the rewards information of the power consumer based on the information of standard consumed power of a group to which the power consumer belongs, the information of first consumed power, and the information of second stored power.

### (Supplementary Note 8)

The rewards information determining device according to Supplementary note 1, wherein the rewards information determining means determines a reduction amount of carbon dioxide of the power consumer based on the information of standard consumed power and the information of first consumed power, and determines the rewards information according to the reduction amount.

### (Supplementary Note 9)

The rewards information determining device according to any one of Supplementary notes 1 to 8, including:

standard consumed power determining means (for example, a standard consumed power calculating unit 31) configured to determine, for each group, the standard consumed power of each group by calculating an average of the first consumed power of power consumers who belong to the group, and store the information of the standard consumed power in standard consumed power storage means (for example, a standard consumed power storage unit 32).

### (Supplementary Note 10)

A rewards information determining system including: power measuring means configured to measure information of first consumed power consumed by a power consumer; and rewards information determining means configured to determine rewards information of the power consumer based on information of standard consumed power of a group to which the power consumer belongs, and the information of first consumed power.

### (Supplementary Note 11)

The rewards information determining system according to Supplementary note 10, wherein the power measuring means measures the information of first consumed power, and information of second consumed power generated by a power generating facility of the power consumer and consumed by the power consumer, and the rewards information determining means determines the rewards information of the power consumer based on the information of standard consumed power of a group to which the power consumer belongs, the information of first consumed power, and the information of second consumed power.

### (Supplementary Note 12)

The rewards information determining system according to Supplementary note 10, wherein the power measuring means measures the information of first consumed power, and information of first stored power generated by a power generating facility of the power consumer and stored to a storage battery, and the rewards information determining means determines the rewards information of the power consumer based on the information of standard consumed power of a group to which the power consumer belongs, the information of first consumed power, and the information of first stored power.

### (Supplementary Note 13)

The rewards information determining system according to Supplementary note 11, wherein the power measuring means measures the information of first consumed power and the information of second consumed power, and measures information of first stored power generated by the power generating facility of the power consumer and stored to the storage battery, and the rewards information determining means determines the rewards information of the power consumer based on the information of standard consumed power of a group to which the power consumer belongs, the information of first consumed power, the information of second consumed power, and the information of first stored power.

### (Supplementary Note 14)

The rewards information determining system according to Supplementary note 12 or 13, wherein the power measuring means measures information of power stored to the storage battery of surplus power of when supplied power from the power generating facility of the power consumer exceeds power consumed in devices of the power consumer, as the information of first stored power.

### (Supplementary Note 15)

The rewards information determining system according to any one of Supplementary notes 11 to 14, wherein the power measuring means measures information of power generated by the power generating facility of the power consumer having a smaller emission constant of carbon dioxide than an emission constant of carbon dioxide of a power company, and consumed by the power consumer, as the information of second consumed power.

### (Supplementary Note 16)

The rewards information determining system according to Supplementary note 10, wherein the power measuring means measures the information of first consumed power, and information of second stored power stored to a storage battery with power supplied in a time zone in which a power purchase price is relatively low, and the rewards information determining means determines the rewards information of the power consumer based on the information of standard consumed power of a group to which the power consumer belongs, the information of first consumed power, and the information of second stored power.

### (Supplementary Note 17)

The rewards information determining system according to Supplementary note 10, wherein the rewards information determining means determines a reduction amount of carbon dioxide of the power consumer based on the information of standard consumed power and the information of first consumed power, and determines the rewards information according to the reduction amount.

### (Supplementary Note 18)

The rewards information determining system according to any one of Supplementary notes 10 to 17, including: standard consumed power determining means configured to determine, for each group, the standard consumed power of each group by calculating an average of the first consumed power of power consumers who belong to the group, and store the information of the standard consumed power in standard consumed power storage means.

### (Supplementary Note 19)

A rewards information determining method including: acquiring information of first consumed power consumed by a power consumer; and determining rewards information of the power consumer based on information of standard consumed power of a group to which the power consumer belongs, and the information of first consumed power.

### (Supplementary Note 20)

The rewards information determining method according to Supplementary note 19, including acquiring the information of first consumed power and information of second consumed power generated by a power generating facility of the power consumer and consumed by the power consumer, and determining the rewards information of the power consumer based on the information of standard consumed power of a group to which the power consumer belongs, the information of first consumed power, and the information of second consumed power.

### (Supplementary Note 21)

The rewards information determining method according to Supplementary note 19, including acquiring the information of first consumed power and information of first stored power generated by a power generating facility of the power consumer and stored to a storage battery, and determining the rewards information of the power consumer based on the information of standard consumed power of a group to which the power consumer belongs, the information of first consumed power, and the information of the first stored power.

### (Supplementary Note 22)

The rewards information determining method according to Supplementary note 20, including acquiring the information of first consumed power and the information of second consumed power, and information of first stored power generated by the power generating facility of the power consumer and stored to a storage battery, and determining the rewards information of the power consumer based on the information of standard consumed power of a group to which the power consumer belongs, the information of first consumed power, the information of second consumed power, and the information of first stored power.

### (Supplementary Note 23)

The rewards information determining method according to Supplementary note 21 or 22, wherein the information acquiring means acquires information of power stored in the storage battery, of surplus power of when supplied power from the power generating facility of the power consumer exceeds power consumed in devices of the power consumer, as the information of first stored power.

### (Supplementary Note 24)

The rewards information determining method according to any one of Supplementary notes 20 to 23, wherein the information acquiring means acquires information of power generated by a power generating facility of the power consumer having a smaller emission constant of carbon dioxide than an emission constant of carbon dioxide of a power company, and consumed by the power consumer, as the information of second consumed power.

### (Supplementary Note 25)

The rewards information determining method according to Supplementary note 19, including acquiring the information of first consumed power and information of second stored power stored to a storage battery with power supplied in a time zone in which a power purchase price is relatively low, and determining the reward information of the power consumer based on the information of standard consumed power of a group to which the power consumer belongs, the information of first consumed power, and the information of second stored power.

### (Supplementary Note 26)

The rewards information determining method according to Supplementary note 19, wherein the rewards information determining means determines a reduction amount of carbon dioxide of the power consumer based on the information of standard consumed power and the information of first consumed power, and determines the rewards information according to the reduction amount.

### (Supplementary Note 27)

The rewards information determining method according to any one of Supplementary notes 19 to 26, including: standard consumed power determining means configured to determine, for each group, the standard consumed power of each group by calculating an average of the first consumed power of power consumers who belong to the group, and store the information of the standard consumed power in standard consumed power storage means.

### (Supplementary Note 28)

A rewards information determining program for causing a computer to execute:

information acquiring processing of acquiring information of first consumed power consumed by a power consumer; and rewards information determining processing of determining rewards information of the power consumer based on information of standard consumed power of a group to which the power consumer belongs, and the information of first consumed power.

### (Supplementary Note 29)

The rewards information determining program according to Supplementary note 28, for causing the computer to acquire the information of first consumed power and information of second consumed power generated by a power generating facility of the power consumer and consumed by the power consumer in the information acquiring processing, and to determine the rewards information of the power consumer based on the information of standard consumed power of a group to which the power consumer belongs, the information of first consumed power, and the information of second consumed power in the rewards information determining processing.

### (Supplementary Note 30)

The rewards information determining program according to Supplementary note 28, for causing the computer to acquire the information of first consumed power and information of first stored power generated by a power generating facility of the power consumer and stored to a storage battery in the information acquiring processing, and to determine the rewards information of the power consumer based on the information of standard consumed power of a group to which the power consumer belongs, the information of first consumed power, and the information of first stored power in the rewards information determining processing.

### (Supplementary Note 31)

The rewards information determining program according to Supplementary note 29, for causing the computer to acquire the information of first consumed power and the information of second consumed power and to acquire information of first stored power generated by the power generating facility of the power consumer and stored to a storage battery in the information acquiring processing, and to determine the rewards information of the power consumer based on the information of standard consumed power of a group to which the power consumer belongs, the information of first consumed power, the information of second consumed power, and the information of first stored power in the rewards information determining processing.

### (Supplementary Note 32)

The rewards information determining program according to Supplementary note 30 or 31, for causing the computer to acquire information of power stored to the storage battery of surplus power of when supplied power from the power generating facility of the power consumer exceeds power consumed in devices of the power consumer, as the information of first stored power, in the information acquiring processing.

### (Supplementary Note 33)

The rewards information determining program according to any one of Supplementary notes 29 to 32, for causing the computer to acquire information of power generated by the power generating facility of the power consumer having a smaller emission constant of carbon dioxide than an emission constant of carbon dioxide of a power company, and consumed by the power consumer, as the information of second consumed power, in the information acquiring processing.

### (Supplementary Note 34)

The rewards information determining program according to Supplementary note 28, for causing the computer to acquire the information of first consumed power and information of second stored power stored to a storage battery with power supplied in a time zone in which a power purchase price is relatively low in the information acquiring processing, and to determine the rewards information of the power consumer based on the information of standard consumed power of a group to which the power consumer belongs, the information of first consumed power, and the information of second stored power in the rewards information determining processing.

### (Supplementary Note 35)

The rewards information determining program according to Supplementary note 28, for causing the computer to determine a reduction amount of carbon dioxide of the power consumer based on the information of standard consumed power and the information of first consumed power, and to determine the rewards information according to the reduction amount in the rewards information determining processing.

### (Supplementary Note 36)

The rewards information determining program according to any one of Supplementary notes 28 to 35, for causing the computer to execute standard consumed power determining processing to determine, for each group, the standard consumed power of the each group by calculating an average of the first consumed power of power consumers who belong to the group, and to store the information of standard consumed power to standard consumed power storage means.

### (Supplementary Note 37)

A rewards information calculating system including a power measuring device (for example, a HEMS 10) configured to measure consumed power of a power consumer, and a rewards information calculating device (for example, rewards information calculating device 30) configured to calculate rewards information that indicates rewards to be provided to the power consumer according to the degree of power saving according to the consumed power of the power consumer, wherein the power measuring device includes power measuring means (for example, power measuring unit 12) that measures the consumed power of the power consumer, and the rewards information calculating device includes standard consumed power storage means (for example, a standard consumed power storage unit 32) that stores, for each group, standard consumed power of power consumers classified based on an attribute of the power consumers, and reward information calculating means (for example, rewards information calculating unit 33) that calculates the rewards information of the power consumer based on the standard consumed power of the group to which the power consumer belongs and the consumed power of the power consumer.

### (Supplementary Note 38)

The rewards information calculating system according to Supplementary note 37, wherein the power measuring means measures the consumed power of the power consumer, and self-consumed power that is power generated by a power consumer power generating device (for example, domestic power generating devices 45a and 45b) having a smaller emission constant of carbon dioxide than an emission constant of carbon dioxide of a power company, and consumed by the power consumer, and the reward information calculating means calculates the rewards information of the power consumer based on the standard consumed power of the group to which the power consumer belongs, the consumed power of the power consumer, and the self-consumed power.

### (Supplementary Note 39)

The rewards information calculating system according to Supplementary note 38, wherein the power measuring means measures the consumed power of the power consumer and the self-consumed power, and stored power that is power generated by the power consumer power generating device and stored to a storage battery, and the reward information calculating means calculates the rewards information of the power consumer based on the standard consumed power of the group to which the power consumer belongs, the consumed power of the power consumer, the self-consumed power, and the stored power.

### (Supplementary Note 40)

The rewards information calculating system according to any one of Supplementary notes 37 to 39, wherein the power measuring means measures the consumed power of the power consumer, and nighttime stored power that is power stored to a storage battery with power supplied in the nighttime from a power company, and the reward information calculating means calculates the rewards information of the power consumer based on the standard consumed power of the group to which the power consumer belongs, the consumed power of the power consumer, and the nighttime stored power.

### (Supplementary Note 41)

The rewards information calculating system according to any one of Supplementary notes 37 to 40, wherein the reward information calculating means calculates a reduction amount of carbon dioxide by power saving of the power consumer based on the standard consumed power and a result of measurement by the power measuring means, and calculates the rewards information according to the reduction amount.

### (Supplementary Note 42)

The rewards information calculating system according to any one of Supplementary notes 37 to 41, wherein the rewards information calculating device includes standard consumed power calculating means (for example, a standard consumed power calculating unit 31) that calculates, for each group, the standard consumed power of the each group by calculating an average of consumed power of power consumers who belongs to the group, and stores the standard consumed power of the each group to standard consumed power storage means.

### (Supplementary Note 43)

A rewards information calculating device that calculates rewards information that indicates rewards to be provided to a power consumer according to the degree of power saving according to consumed power of the power consumer, the device including standard consumed power storage means configured to store, for each group, standard consumed power of power consumers classified based on an attribute of the power consumers, and reward information calculating means configured to acquire the consumed power of the power consumer and calculate the rewards information of the power consumer based on the standard consumed power of the group to which the power consumer belongs, and the consumed power of the power consumer.

### (Supplementary Note 44)

A rewards information calculating method executed by a power measuring device that measures consumed power of a power consumer, and a rewards information calculating device that calculates rewards information that indicates rewards to be provided to the power consumer according to the degree of power saving according to the consumed power of the power consumer, wherein the rewards information calculating device stores, for each group, standard consumed power of power consumers classified based on an attribute of the power consumers, the power measuring device measures the consumed power of the power consumer, and the rewards information calculating device calculates the rewards information of the power consumer based on the standard consumed power of the group to which the power consumer belongs, and the consumed power of the power consumer.

### (Supplementary Note 45)

A rewards information calculating program incorporated to a computer that includes a standard consumed power storage means that stores, for each group, standard consumed power of power consumers classified based on an attribute of the power consumers, and calculates rewards information that indicates rewards to be provided to the power consumer according to the degree of power saving according to consumed power of the power consumer, and the program for causing the computer to execute rewards information calculation processing of acquiring the consumed power of the power consumer, and calculating the rewards information of the power consumer based on the standard consumed power of the group to which the power consumer belongs, and the consumed power of the power consumer.

As described above, the invention of the present application has been described with reference to the exemplary embodiments. However, the invention of the present application is not limited to the exemplary embodiments. Various modifications that can be understood by a person skilled in the art can be made to the configurations and the details of the invention of the present application within the scope of the invention of the present application.

This application claims benefits of Japanese Patent Application No. 2013-224979 filed on Oct. 30, 2013, the entire disclosure of which is incorporated herein by reference.

### INDUSTRIAL APPLICABILITY

The present invention is favorably applied to a power saving point calculating system that calculates a point that indicates the degree of power saving of a power consumer.

### REFERENCE SIGNS LIST

10 Power measuring device
11 Power supply unit
12 Power measuring unit
13 Information transmitting unit
20 Information storage server
21 Power storage unit
22 Control unit
30 Rewards information calculating device
31 Standard consumed power calculating unit
32 Standard consumed power storage unit
33 Rewards information calculating unit
40 Point server

1. A rewards information determining device comprising:
an information acquiring unit configured to acquire information of first consumed power consumed by a power consumer; and
a rewards information determining unit configured to determine rewards information of the power consumer based on information of standard consumed power of a group to which the power consumer belongs, and the information of first consumed power.

2. The rewards information determining device according to claim 1, wherein
the information acquiring unit acquires the information of first consumed power, and information of second consumed power generated by a power generating facility of the power consumer and consumed by the power consumer, and
the rewards information determining unit determines the rewards information of the power consumer based on the information of standard consumed power of a group to which the power consumer belongs, the information of first consumed power, and the information of second consumed power.

3. The rewards information determining device according to claim 1, wherein
the information acquiring unit acquires the information of first consumed power, and information of first stored power generated by a power generating facility of the power consumer and stored in a storage battery, and
the rewards information determining unit determines the rewards information of the power consumer based on the information of standard consumed power of a group to which the power consumer belongs, the information of first consumed power, and the information of first stored power.

4. The rewards information determining device according to claim 2, wherein
the information acquiring unit acquires the information of first consumed power and the information of second consumed power, and information of first stored power generated by the power generating facility of the power consumer and stored in a storage battery, and
the rewards information determining unit determines the rewards information of the power consumer based on the information of standard consumed power of a group to which the power consumer belongs, the information of first consumed power, the information of second consumed power, and the information of first stored power.

5. The rewards information determining device according to claim 3, wherein
the information acquiring unit acquires information of power stored in the storage battery, of surplus power of when supplied power from the power generating facility of the power consumer exceeds power consumed in devices of the power consumer, as the information of first stored power.

6. The rewards information determining device according to claim 2, wherein
the information acquiring unit acquires information of power generated by a power generating facility of the power consumer having a smaller emission constant of carbon dioxide than an emission constant of carbon dioxide of a power company, and consumed by the power consumer, as the information of second consumed power.

7. The rewards information determining device according to claim 1, wherein
the information acquiring unit acquires the information of first consumed power, and information of second stored power stored in a storage battery with power supplied in a time zone where a power purchase price is relatively low, and
the rewards information determining unit determines the rewards information of the power consumer based on the information of standard consumed power of a group to which the power consumer belongs, the information of first consumed power, and the information of second stored power.

8. The rewards information determining device according to claim 1, wherein
the rewards information determining unit determines a reduction amount of carbon dioxide of the power consumer based on the information of standard consumed power and the information of first consumed power, and determines the rewards information according to the reduction amount.

9. The rewards information determining device according to claim 1, comprising:
a standard consumed power determining unit configured to determine, for each group, the standard consumed power of each group by calculating an average of the first consumed power of power consumers who belong to the group, and store the information of the standard consumed power in a standard consumed power storage unit.

10. A rewards information determining system comprising:
a power measuring unit configured to measure information of first consumed power consumed by a power consumer; and
a rewards information determining unit configured to determine rewards information of the power consumer based on information of standard consumed power of a group to which the power consumer belongs, and the information of first consumed power.

11. A rewards information determining method comprising:
acquiring information of first consumed power consumed by a power consumer; and
determining rewards information of the power consumer based on information of standard consumed power of a group to which the power consumer belongs, and the information of first consumed power.

12. A non-transitory computer readable recording medium in which a rewards information determining program is recorded, the rewards information determining program causing a computer to execute:
information acquiring processing of acquiring information of first consumed power consumed by a power consumer; and
rewards information determining processing of determining rewards information of the power consumer based on information of standard consumed power of a group to which the power consumer belongs, and the information of first consumed power.
